(19) United States
(12) Patent Application Publication
(10) Pub. No.: US 2013/0100274 A1
(43) Pub. Date: Apr. 25, 2013

(54) ENDOSCOPE APPARATUS

(71) Applicant: Olympus Corporation, Tokyo (JP)

(72) Inventors: AYUMI DOI, Tokyo (JP); Susumu Takahashi, Iruma-shi (JP)

(73) Assignee: Olympus Corporation, Tokyo (JP)

(21) Appl. No.: 13/712,318

(22) Filed: Dec. 12, 2012

Related U.S. Application Data
(63) Continuation-in-part of application No. PCT/JP2011/061977, filed on May 25, 2011.

(51) Int. Cl. H04N 7/18

(52) U.S. Cl. CPC H04N 7/18
USPC 348/82

(57) ABSTRACT

Provided is an endoscope apparatus including an illumination unit and an image acquisition unit, wherein the illumination unit has a light emission unit at which a light source is installed, and a mask configured to shield some of the light emitted from the light emission unit, and when an irradiation angle of the light measured when an optical axis of the light emission unit is set to 0° is set to θ, a function of the irradiation angle θ representing angular distribution of the light emitted from the light emission unit is set to f(θ), and a maximum angle defined to be vignetted by the mask when the optical axis of the light emission unit is set to 0° is set to θ₁, energy V of the light passing through the mask represented by the following equation 1 is 35 mW or less.

[Equation 1]

V=2π∫θƒ(θ)dθ where (0≦θ≦θ₁) (Equation 1)

### TECHNICAL FIELD

The present invention relates to an endoscope apparatus.

### BACKGROUND ART

In the related art, an endoscope apparatus is used to observe an inner structure of an observation object. The endoscope apparatus includes an illumination unit configured to illuminate an inside of an observation object, and an image acquisition unit configured to acquire an image of the observation object illuminated by the illumination unit, so that an observer can see an image acquired by the image acquisition unit. In particular, an industrial endoscope may be used in a zone in which an observer cannot easily directly observe an observation object because a combustible gas or dust is present.

As an example of the illumination unit used in the endoscope apparatus, a diffusion illumination optical system for an endoscope is disclosed in Patent Document 1. The diffusion illumination optical system for an endoscope disclosed in Patent Document 1 has a concave lens, in which a plurality of concave surfaces having different curvatures in a concentric manner are formed as a lens configured to emit illumination light. According to the diffusion illumination optical system for an endoscope disclosed in Patent Document 1, a light distribution property in which a light density of a peripheral portion is increased can be obtained.

### RELATED ART DOCUMENT

### Patent Document

[Patent Document 1] Japanese Unexamined Patent Application, First Publication No. H-06-273678

### SUMMARY OF THE INVENTION

### Problems to be Solved by the Invention

A zone in which the combustible gas, dust or the like is present is a dangerous zone in which ignition or explosion may occur. Illumination of an instrument used in the dangerous zone is required to satisfy an explosion-proof standard defined in IEC60079-28. In the explosion-proof standard defined in IEC60079-28, an upper limit of gross energy of the illumination light and illuminance per unit area are standardized. However, when the gross energy or illuminance of the illumination light are set to low levels to merely satisfy the standard, a quantity of light of the illumination light becomes insufficient so that an image of the observation object is darkened to make it difficult to easily observe the observation object.

In consideration of the above-mentioned circumstances, the present invention is directed to provide an endoscope apparatus capable of radiating illumination light having a sufficient quantity of light in a range in which explosion-proof standard is satisfied.

### Means for Solving the Problems

A first aspect of the present invention provides an endoscope apparatus including: an illumination unit configured to radiate an illumination light to an observation object; and an image acquisition unit configured to acquire an image of the observation object to which the illumination light is radiated, wherein the illumination unit has: a light emission unit at which a light source configured to emit the illumination light is installed; and a mask configured to shield some of the illumination light emitted from the light emission unit, and wherein when an irradiation angle of the illumination light is set to 0 while in a condition where an optical axis of the light emission unit is set to 0°, a function of the irradiation angle θ representing an angular distribution of the illumination light emitted from the light emission unit is set to f(θ), and a maximum angle defined to be vignetted by the mask is set to θ₁ when the optical axis of the light emission unit is set to 0°, an energy V of the light penetrating through the mask represented by the following equation 1 is from 37 μW to 35 mW.

### [Equation 1]

V=2π∫θƒ(θ)dθ where (0≦θ≦θ₁) (Equation 1)

A second aspect of the present invention provides an endoscope apparatus including: an illumination unit configured to radiate an illumination light to an observation object; and an image acquisition unit configured to acquire an image of the observation object irradiated with the illumination light, wherein the illumination unit has: a light emission unit at which a light source configured to emit the illumination light is installed; and a mask configured to shield some of the illumination light emitted from the light emission unit, and wherein when an irradiation angle of the illumination light is set to 0 while in a condition where an optical axis of the light emission unit is set to 0°, a function of the irradiation angle θ representing an angular distribution of the illumination light emitted from the light emission unit is set to f(θ), and a maximum angle defined to be vignetted by the mask is set to θ₁ when the optical axis of the light emission unit is set to 0°, an energy V of the light passing through the mask represented by the following equation 2 is 35 mW or more, and illuminance per 1 mm² of the light passing through the mask is from 0.73 μW to 5 mW.

### [Equation 2]

V=2π∫θƒ(θ)dθ where (0≦θ≦θ₁) (Equation 2)

In addition, in the endoscope apparatus of the first and second aspects, the light emission unit may be a Lambert light source in which a light distribution property thereof approximates f(θ)=L₀·COS (θ), and the energy V of the light satisfies the following equation 3 when energy of the light emitted from the light emission unit in the direction of the irradiation angle θ of 0° is set to l₀.

### [Equation 3]

V=2πl₀(θ₁ sin θ₁+cos θ₁−1) (Equation 3)

Further, in the endoscope apparatus of the first and second aspects, the maximum angle θ₁ may be 20° or more.

Furthermore, in the endoscope apparatus of the first and second aspects, the mask may have an opening in which an opening area is 50 mm² or less.

In addition, in the endoscope apparatus of the first and second aspects, the maximum angle θ₁ may be 20° or more, the mask may have an opening having an opening in which an opening area is 50 mm² or less, and the distance in the optical axial direction between the opening of the mask and the light emission unit may be 0 mm to 11 mm.

Further, in the endoscope apparatus of the first and second aspects, the light emission unit may have at least two light sources as the light source spaced apart from each other about the optical axis in a state in which angles measured from around the optical axis are equal to each other, and disposed to be equidistant from the optical axis.

Furthermore, in the endoscope apparatus of the first and second aspects, the light source may be disposed in an inner region of the opening of the mask when seen in the central axial direction of the mask.

In addition, in the endoscope apparatus of the first and second aspects, a cover glass having optical transparency may be installed on the mask, and the light emitted from the light emission unit may pass through the cover glass to be radiated to the observation object.

Further, in the endoscope apparatus of the first and second aspects, a light distribution control unit configured to control light distribution of the light emitted from the light emission unit such that illuminance of the light output from the cover glass is 0.73 μW/mm² to 5 mW/mm² may be installed on the cover glass.

Furthermore, in the endoscope apparatus of the first and second aspects, grating processing or concavo-convex processing may be performed on a surface of the cover glass directed toward the light emission unit within a range in which illuminance of the light arriving at the surface from the light emission unit is 0.73 μW/mm² to 5 mW/mm², functioning as the light distribution control unit.

In addition, in the endoscope apparatus of the first and second aspects, coloration processing may be performed on the cover glass within a range in which illuminance of the light arriving at the surface of the cover glass from the light emission unit is 0.73 μW to 5 mW/mm², functioning as the light distribution control unit.

### Effect of the Invention

According to the endoscope apparatus of the present invention, illumination light having a sufficient quantity of light within a range in which an explosion-proof standard is satisfied can be radiated.

### BRIEF DESCRIPTION OF THE DRAWINGS

FIG. 1 is a perspective view showing an endoscope apparatus of a first embodiment of the present invention.

FIG. 2 is a cross-sectional view showing an optical adaptor in a cross-section along a central axis of an insertion section.

FIG. 3 is a schematic view showing a light distribution property of an illumination unit.

FIG. 4 is a schematic view showing the a light distribution property of the illumination unit.

FIG. 5 is a graph showing angular distribution of light energy in a modified example of the present invention.

FIG. 6 is a front view of an optical adaptor of an endoscope apparatus of another modified example of the present invention.

FIG. 7 is a cross-sectional view taken along line A-A of FIG. 6.

FIG. 8 is a cross-sectional view taken along line B-B of FIG. 6.

FIG. 9 is a graph showing angular distribution of light emitted from a light emission unit of the modified example.

FIG. 10 is a schematic view showing an illumination state by the light emission unit.

FIG. 11 is a graph showing a relationship between the distance from a light source to a mask and illumination efficiency thereof.

FIG. 12 is a schematic view showing a light distribution property of an illumination unit of an endoscope apparatus of still another modified example of the present invention.

FIG. 13 is a graph showing angular distribution of light emitted from the illumination unit of the modified example.

FIG. 14 is a schematic view showing a light distribution property of an illumination unit of an endoscope apparatus of still another modified example of the present invention.

FIG. 15 is a graph showing angular distribution of light emitted from the illumination unit of the modified example.

FIG. 16 is a graph showing a relationship between a maximum angle and illumination efficiency of illumination light radiated from the illumination unit.

FIG. 17 is a photograph of a color chart shoot by the endoscope apparatus.

FIG. 18 is a photograph of a color chart shoot by the endoscope apparatus.

FIG. 19 is a photograph of a cast metal as an example of the observation object shoot by the endoscope apparatus.

FIG. 20 is a photograph of a cast metal as an example of the observation object shoot by the endoscope apparatus.

### MODES FOR CARRYING OUT THE INVENTION

### First Embodiment

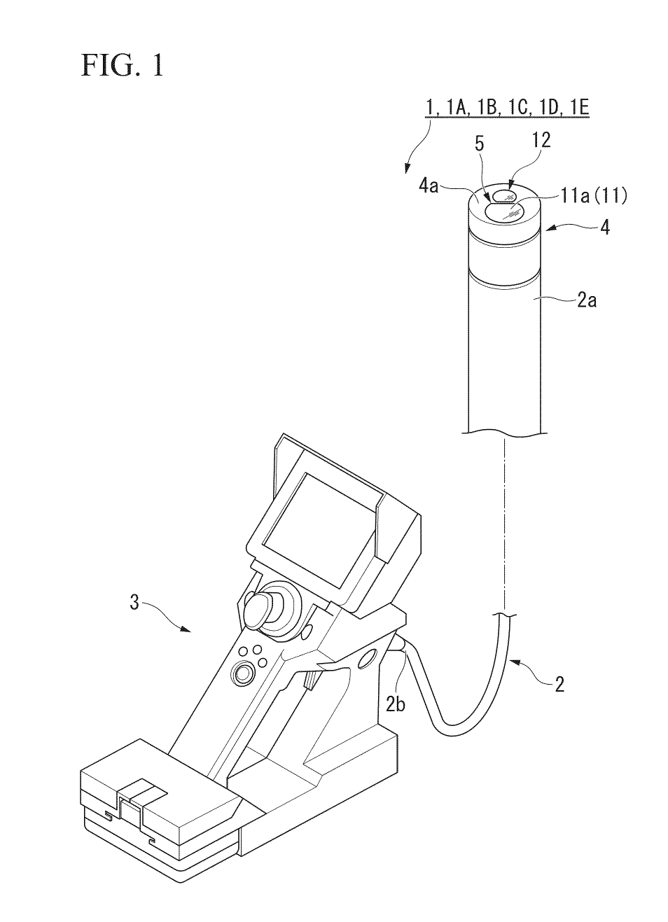

An endoscope apparatus 1 of a first embodiment of the present invention will be described. FIG. 1 is a perspective view showing the endoscope apparatus 1 of the embodiment.

The endoscope apparatus 1 is an apparatus for observing an area that cannot easily be observed directly by an observer, for example, the inside of an observation object. As shown in FIG. 1, the endoscope apparatus 1 includes a long insertion section 2 inserted into the inside of the observation object from a distal end 2a thereof, and a main body 3 to which a proximal end 2b of the insertion section 2 is fixed.

The insertion section 2 is a cylindrical member having flexibility. An optical adaptor 4 detachably attached to the insertion section 2 is installed at the distal end 2a of the insertion section 2.

An illumination unit 5 configured to illuminate illumination light to the observation object and an image acquisition unit 12 configured to acquire an image of the observation object irradiated with the illumination light are installed at the optical adaptor 4. In the embodiment, a direct viewing type adaptor having an imaging field of vision directed in a central axial direction of the insertion section 2 is employed as an example of the optical adaptor 4. In addition, a so-called lateral viewing type optical adaptor 4 having an imaging field of vision in a direction crossing a central axis of the insertion section 2 may be employed as the optical adaptor 4.

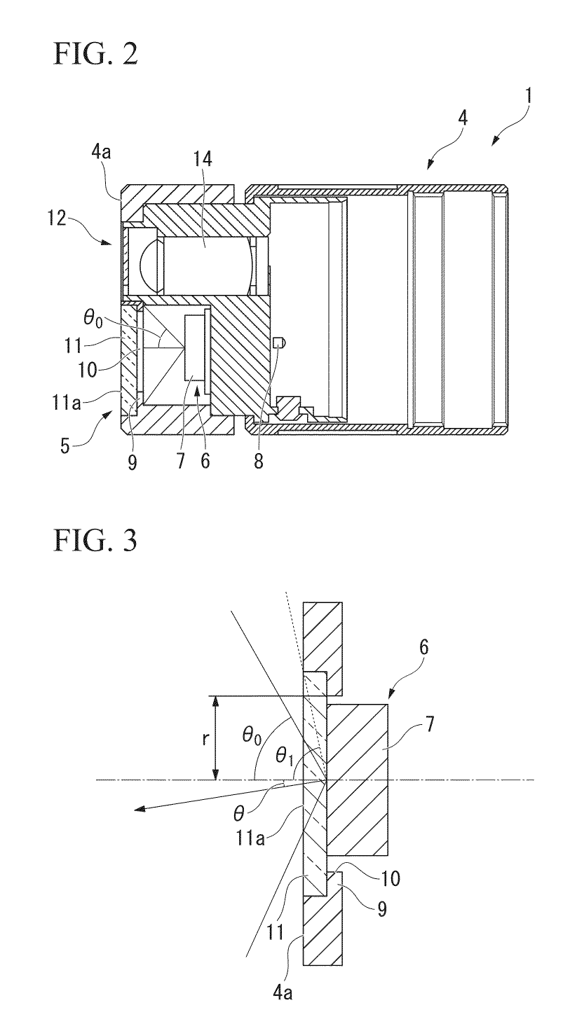

FIG. 2 is a cross-sectional view showing the optical adaptor 4 in a cross-section along a central axis of the insertion section 2.

The illumination unit 5 has a light emission unit 6 and a mask 9 to which a cover glass 11 is fixed.

The light emission unit 6 includes a light source 7 and a terminal 8 configured to supply power to the light source 7. In the embodiment, one light source 7 is installed at the light emission unit 6, and an optical axis of the one light source 7 becomes an optical axis of the light emission unit 6. The light source 7 installed at the light emission unit 6 has a light distribution property similar to a point light source, and radiates visual light within a range that becomes a predetermined irradiation angle θ₀ with respect to the optical axis of the light emission unit 6, which is set to 0°. In addition, in the specification, the irradiation angle of the light emitted from the light emission unit 6 is represented by a magnitude measured with respect to the optical axis of the light emission unit 6, which is set to 0°, and written as a variable θ in an equation. A light emitting diode (LED) or a laser diode may be employed as the light source 7.

The mask 9 functions to shield some of the light emitted from the light emission unit 6 and has an opening 10 having an opening area of 50 mm² or less. While the quantity of light emitted from the light emission unit 6 through the opening 10 can be increased as the are of the opening 10 is increased, a dimension in a radial direction of the optical adaptor 4 is also increased. On the other hand, while the quantity of light emitted from the light emission unit 6 through the opening 10 can be reduced as the area of the opening 10 is reduced, the dimension in the radial direction of the optical adaptor 4 can also be reduced. In addition, when the dimension in the radial direction of the optical adaptor 4 can be substantially increased, the area of the opening 10 may be larger than 50 mm².

A center of the opening 10 of the mask 9 is disposed on the optical axis of the light emission unit 6. In addition, a concave section formed along a contour of the cover glass 11 is formed at the mask 9 to fix the cover glass 11. In a state in which the cover glass 11 is fixed to the mask 9, the cover glass 11 is flush with a distal end surface 4a of the optical adaptor 4.

The cover glass 11 is a plate-shaped optical transparency member having a predetermined thickness. The cover glass 11 closely contacts and is fixed to the mask 9 to close the opening 10. A known glass material may be appropriately selected and employed as a material of the cover glass 11. The cover glass 11 may have any shape as long as the opening 10 can be covered. For example, in the embodiment, the cover glass 11 has a shape in which a portion of an edge of a circular plate is cutout, and is configured such that the distance between the image acquisition unit 12 and the illumination unit 5 is reduced at the distal end surface 4a of the optical adaptor 4. As the cover glass 11 is installed, introduction of liquid, dust or the like into the optical adaptor 4 can be prevented.

The image acquisition unit 12 has an area image sensor (not shown) disposed in the distal end 2a of the insertion section 2, and an optical system 14 configured to form an image of the observation object on the area image sensor. The image acquisition unit 12 is fixed to the optical adaptor 4 in a state in which an imaging field of vision is directed in an optical axial direction of the illumination unit 5. In addition, a fiber bundle in which a plurality of optical fibers are bound may be employed as the image acquisition unit 12.

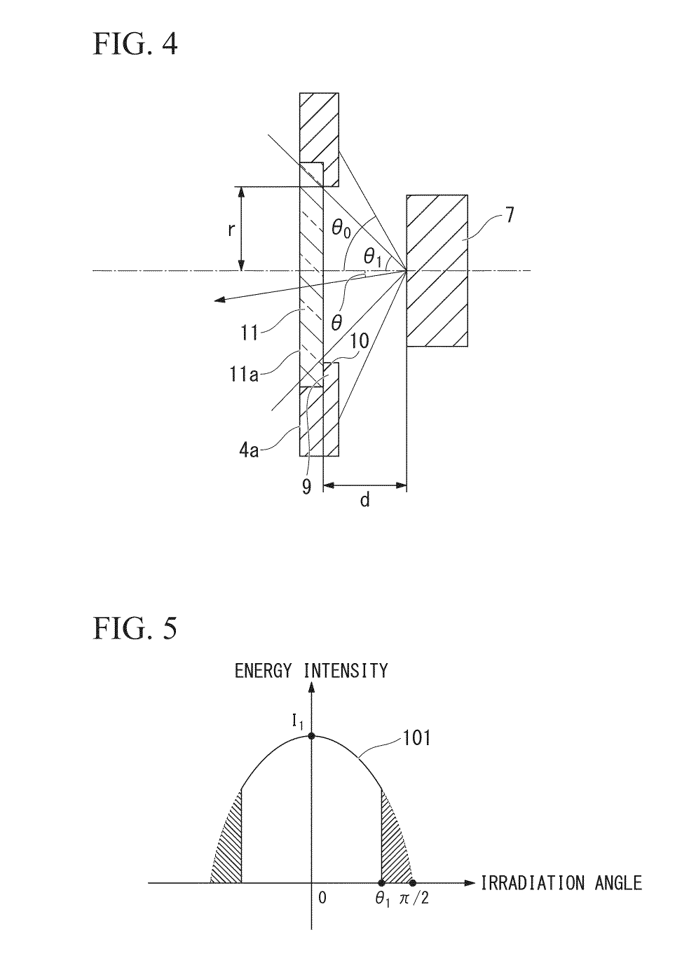

Next, a light distribution property of the illumination unit 5 constituted by the light emission unit 6 and the mask 9 will be described with reference to FIGS. 3 and 4. FIGS. 3 and 4 are schematic views exhibiting a light distribution property of the illumination unit 5.

As shown in FIG. 3, when the distance between the opening 10 and the light emission unit 6 is reduced, the light emitted from the light emission unit 6 is not shielded by the mask 9 or a shielded amount is small. For example, when a positional relationship in which the light emission unit 6 is in contact with the rear end surface of the cover glass 11 is provided, an irradiation angle θ is substantially equal to a predetermined irradiation angle θ₀.

As shown in FIG. 4, as the distance between the opening 10 and the light emission unit 6 is increased, a peripheral portion of the light emitted from the light emission unit 6 is shielded by the mask 9 to cause so called vignetting.

Among the light emitted from the light emission unit 6, the light passing through the opening 10 of the mask 9 passes through the cover glass 11 to be radiated to the observation object from the distal end surface 4a of the optical adaptor 4 to be used to illuminate the observation object. Since the light shielded by the mask 9 is absorbed by the mask 9 or reflected by an outer surface of the mask 9, the light is not radiated to the observation object.

In the embodiment, some of the light emitted from the light emission unit 6 may be vignetted by the mask 9. A maximum angle θ₁, which is a maximum value of the irradiation angle θ of the light passing through the opening 10 of the mask 9 and radiated to the outside, satisfies a relationship shown in the following Equation 4, when a radius of the opening 10 of the mask 9 is set to r and the distance between the mask 9 and the light emission unit 6 is set to d.

$$\begin{matrix}[ Equation 4 ] & \\ d = \frac{r}{tan {θ}_{1}} & ( Equation 4 )\end{matrix}$$

In addition, in order to secure the same irradiation angle as of the illumination light radiated to a conventional endoscope, the magnitude of the maximum angle θ₁ is set to 20° or more. In this case, when the mask 9 in which the radius of the opening 10 is 4 mm or less is employed, the distance d between the mask 9 and the light emission unit 6 is set to be within a range of 0 mm to 11 mm.

In addition, for example, when the light from the light source 7 is not shielded by the mask 9 as shown in FIG. 3, the predetermined irradiation angle θ₀ may be an actual maximum irradiation angle regardless of the maximum angle θ₁.

Energy V of the light passing through the opening 10 of the mask 9 and radiated to the outside is represented using a function f(θ) of the irradiation angle θ showing the angular distribution of the light emitted from the light emission unit 6 as represented by the following equation 5.

### [Equation 5]

V=2π∫θƒ(θ)dθ where (0≦θ≦θ₁) (Equation 5)

In the present embodiment, the energy V of the light passing through the opening 10 of the mask 9 and radiated to the outside is 35 mW or less. Specifically, the energy V of the light is gross energy of the light measured on a distal end surface 11a of the cover glass 11. As the gross energy of the light on the distal end surface 11a of the cover glass 11 is set to 35 mW or less, energy radiated from the optical adaptor 4 to the outside is always 35 mW or less. Accordingly, the illumination unit 5 satisfies the explosion-proof standard defined in IEC60079-28. In addition, the energy V of the light may be increased within a range not exceeding 35 mW.

In order to set the energy V of the light to 35 mW or less, a method of applying the light source 7 having the energy V₀ of 35 mW or less of the light emitted from the light emission unit 6 to the light emission unit 6 or a method of increasing the distance d between the opening 10 and the light emission unit 6 may be employed.

According to the method of applying the light source 7 having the energy V₀ of 35 mW or less of the light emitted from the light emission unit 6 to the light emission unit 6, the distance between the opening 10 and the light emission unit 6 can be reduced. In addition, in this case, since the energy V of the light is 35 mW or less even when all of the light emitted from the light emission unit 6 is radiated to the outside, there is no need to shield the light with the mask 9. Accordingly, the irradiation angle θ can be increased and the length of a hard portion of a distal end of the insertion section 2 can be decreased.

According to the method of increasing the distance d between the opening 10 and the light emission unit 6, some of the light emitted from the light emission unit 6 is shielded by the mask 9. In this case, a ratio (V/V₀, hereinafter referred to as “illumination efficiency”) of the energy V of the light passing through the opening 10 of the mask 9 and radiated to the outside with respect to the energy V₀ of the light emitted from the light emission unit 6 is reduced.

In the present embodiment, when the method of increasing the distance d between the opening 10 and the light emission unit 6 is employed, the maximum angle θ₁ is set in consideration of the illumination light efficiency.

Next, a desirable lower limit of the energy V of the light emitted from the illumination unit 5 will be described with experimental result.

A light emitted from the illumination unit 5 is required to be a bright light so as to observe the observation object. Accordingly, a practical requirement may not be satisfied even though the illumination unit 5 is configured to emit energy of the light having a dramatically low energy with the intention to satisfy only the standard defined in IEC60079-28.

First, a desirable state of an endoscope image on normal using of the endoscope apparatus will be described. The endoscope apparatus acquires an image of the observation object by the image acquisition unit provided to the insertion section. Then, the image acquired by the image acquisition unit is displayed on a liquid crystal panel or the like, and is observed by the user of the endoscope apparatus.

In the image acquired by the image acquisition unit, various objects including the observation object are displayed, and if a light having energy in which the user of the endoscope apparatus distinguishes the observation object from a back ground is emitted from the illumination unit 5, the user can observe the observation object.

One element for distinguishing the observation object from the back ground is a contrast of the observation object and a contrast of the back ground. For example, in case in which the acquisition unit is configured to acquire a monochrome image, with regard to the contrast of the observation object and the contrast of the back ground, it is required to emit a light from the illumination unit 5 so as to obtain a contrast having a size in which the user can recognize.

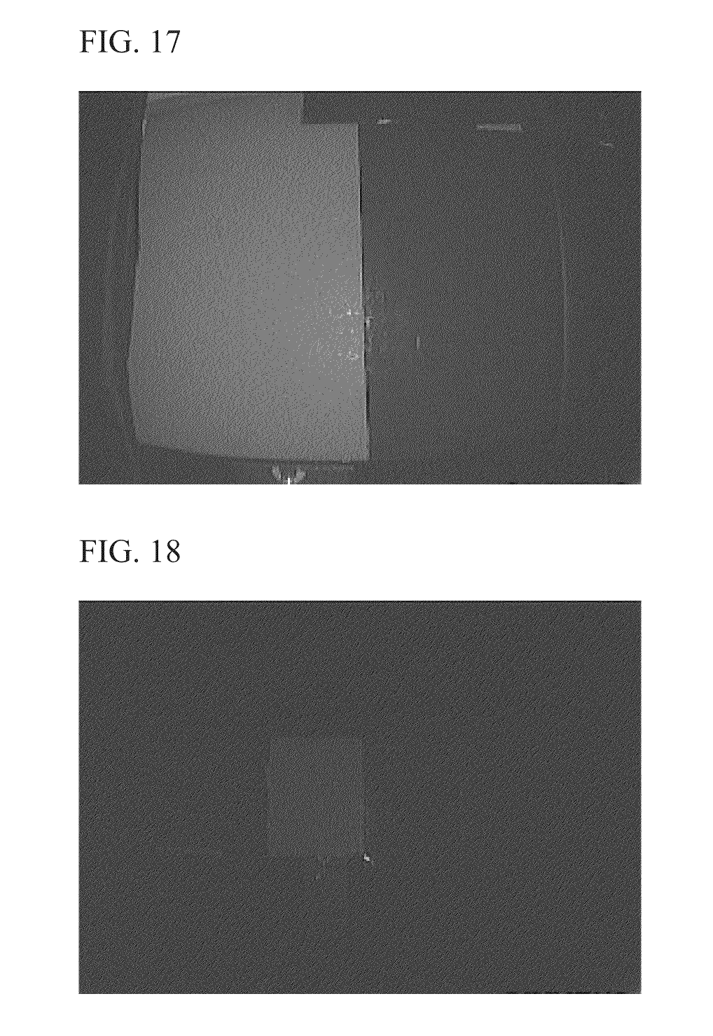

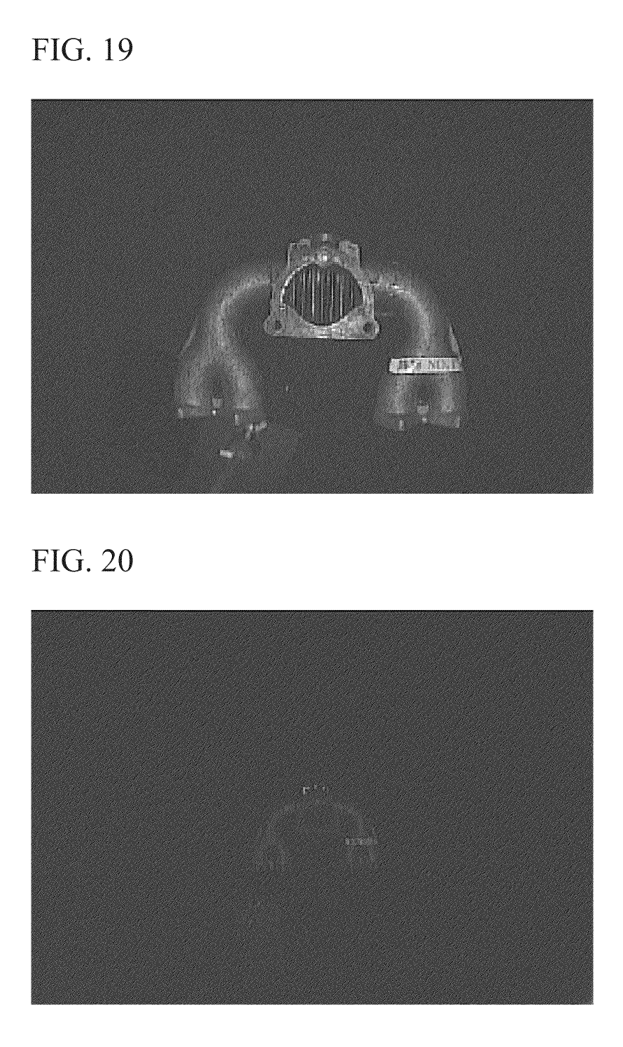

FIG. 17 shows an endoscope image when a color chart, in which a left side thereof is colored by gray of 13% and a right side thereof is colored by gray 4.5%, is shoot at a position apart from the color chart with 300 mm in a dark room. FIG. 18 shows an endoscope image when a color chart, in which a left side thereof is colored by gray of 13% and a right side thereof is colored by gray 4.5%, is shoot at a position apart from the color chart with 800 mm in a dark room. FIGS. 19 and 20 show an endoscope image of the cast metal shoot as one example of the envisaged observation object, and FIG. 19 shows the cast metal shoot at a position apart from that with 300 mm and FIG. 19 shows the cast metal shoot at a position apart from that with 800 mm.

Combination of a color of the color chart is selected on the assumption of actual shooting in consideration of colors of the cast metal and the back ground.

Experiment is performed using an endoscope apparatus in which energy of the illumination light is 58 mW. In addition, in an optical adaptor installed at the endoscope apparatus, it is assumed that the distance to the observation object is about 300 mm.

As shown by FIGS. 17 and 18, and following table 1, more a contrast of an image decreases, the more the distance to the observation object is increase. As a result of the experiment, in the endoscope apparatus, the maximum distance in which the user can distinguish the observation object from the back ground is 800 mm, and the contrast is 1.2 at this time.

TABLE 1

| | | Contrast |
|---|---|---|
| distance | 800 mm | 1.2 |
| | 300 mm | 2.4 |

Based on the above, the endoscope apparatus of the present embodiment, energy V of the light is defined so as to observe the observation object with a contrast of 1.2 or more when observation is performed at a position apart from predetermined distance with respect to the observation object.

For example, in the endoscope apparatus of the present embodiment, if lower limit of required energy V of the light is x and the distance to the observation object is L, the amount of lower limit of energy V of the light for obtaining a contrast equivalent of the endoscope apparatus used at the above experiment is set to satisfy x=58/(800/L)².

In addition, the opening 10 has an opening area of 50 mm² or less, however, for example, the opening 10 has an opening area of 50 mm², lower limit y of the illuminance per 1 mm² is calculated by y=x/50.

For example, it is assumed that the distance to the observation object is 20 mm, lower limit x of the amount of energy V the light is 37 μW, and lower limit y of the illuminance per 1 mm² is 0.73 μW/mm².

In addition, it is assumed that the distance to the observation object is 300 mm, lower limit x of the amount of energy V the light is 8.2 mW, and lower limit y of the illuminance per 1 mm² is 0.16 mW/mm².

In addition, in case in which energy of the light is 35 mW, when the observation object is present apart from 620 mm, it is possible to observe the observation object with contrast of 1.2.

An operation of the endoscope apparatus 1 having the above-mentioned configuration will be described.

In use of the endoscope apparatus 1, the observer who observes the observation object using the endoscope apparatus 1 inserts the insertion section 2 into a space such as the inside of the observation object from the distal end 2a side.

For example, when external light arriving at the inside of the observation object is small, the image of the inside of the observation object may be darkened when only the external light is used. In this case, the light source 7 of the light emission unit 6 of the illumination unit 5 is turned on.

When the light source 7 is turned on, the light emitted from the light source 7 passes through the opening 10 of the mask 9 along the optical axis of the light emission unit 6, and further passes through the cover glass 11 to be radiated to the outside of the optical adaptor 4. Accordingly, the observation object is illuminated.

Here, since the energy V of the light on the distal end surface 11a of the cover glass 11 is 35 mW or less, the explosion-proof standard defined in IEC60079-28 is satisfied. For this reason, according to the endoscope apparatus 1 of the embodiment, even in the space in which the combustible gas or dust is present, the illumination light can be radiated with a sufficient quantity of light within a range that satisfies the explosion-proof standard.

In addition, since the maximum angle θ₁ is set to 20° or more, the illumination light can be radiated to the observation object at the same irradiation angle as in the conventional endoscope.

Further, since the mask 9 has the opening 10 having an area of 50 mm² or less, the explosion-proof standard can be satisfied and the dimension in the radial direction of the optical adaptor 4 can be equal to or less than an outer dimension of the insertion section 2 in the conventional endoscope.

Furthermore, since the distance d between the opening 10 of the mask 9 and the light emission unit 6 is 0 mm to 11 mm, the explosion-proof standard can be satisfied and the length of the hard portion of the insertion section 2 can be equal to or less than the length of that in the related art.

### Second Embodiment

Next, an endoscope apparatus of a second embodiment of the present invention will be described. In addition, hereinafter, the same components described in the above-mentioned first embodiment are designated by the same reference numerals, and an overlapping description will be omitted here.

While an endoscope apparatus 1A (see FIG. 1) of the present embodiment has the same configuration as the endoscope apparatus 1 described in the above-mentioned first embodiment, energy of light emitted from the distal end surface 11a of the cover glass 11 is 35 mW or more. Further, illuminance of the light emitted from the light emission unit 6 and emitted from the front end surface 11a of the cover glass 11 is set to 5 mW or less per 1 mm². In addition, in the specification, illuminance of the light emitted from the distal end surface 11a of the cover glass 11 indicates a magnitude of the illuminance measured on the distal end surface 11a of the cover glass 11.

Specifically, the illuminance per 1 mm² of the light emitted from the distal end surface 11a of the cover glass 11 is set such that the illuminance per 1 mm² at the irradiation angle having the highest energy is 5 mW or less, based on a measurement value of the illuminance per 1 mm² at the irradiation angle having the highest energy within a range in which the irradiation angle θ of the light emitted from the light emission unit 6 is 0≦θ≦θ₁.

The light emitted from the distal end surface 11a of the cover glass 11 is the radiated light in which the irradiation angle θ is 0≦θ≦θ₁. For this reason, the light emitted from the cover glass 11 is diffused to arrive at the observation object, and the illuminance of the light arriving at the observation object must be 5 mW/mm². Accordingly, the illumination unit 5 of the endoscope apparatus 1 of the embodiment satisfies the explosion-proof standard defined in IEC60079-28.

Similar to the above-mentioned endoscope apparatus 1, even in the space in which the combustible gas or dust is present, the illumination light having a sufficient quantity of light within a range satisfying the explosion-proof standard can be radiated by the endoscope apparatus 1A of the embodiment.

Further, according to the endoscope apparatus 1A of the embodiment, the explosion-proof standard can be satisfied even when the light emission unit 6 and the mask 9 having gross energy of the illumination light radiated from the optical adaptor 4 to the outside exceeding 35 mW are employed.

### Modified Example 1

Next, modified example of the endoscope apparatuses 1 and 1A of the above-mentioned first and second embodiments will be described. An endoscope apparatus 1B of the present modified example is characterized in that the light source 7 installed at the light emission unit 6 is a Lambert light source. Angular distribution of the light emitted from the light source 7 is represented as the following equation 6 when energy of the light emitted from the light emission unit 6 in a direction of the irradiation angle θ of 0° is set to l₀.

### [Equation 6]

ƒ(θ)=l₀ cos θ (Equation 6)

FIG. 5 is a graph showing angular distribution of light energy of the present modified example. A line designated by reference numeral 101 of FIG. 5 represents energy intensity of the light emitted from the light source 7. As shown in FIG. 5, in the angular distribution of the light energy of the present modified example, the energy at a position at which the irradiation angle θ is 0° is maximized. In addition, since the light is shielded by the mask 9 outside of the maximum angle θ₁, the energy of the light passing through the opening 10 and radiated to the outside of the optical adaptor 4 becomes 0 outside of the maximum angle θ₁.

In the present modified example, the energy V of the light radiated from the light emission unit 6 penetrating through the mask 9 satisfies the following equation 7.

### [Equation 7]

V=2πl₀(θ₁ sin θ₁+cos θ₁−1) (Equation 7)

Further, the illumination efficiency (V/V₀), which is the ratio of the energy V of the light passing through the opening 10 of the mask 9 and radiated to the outside, with respect to the energy V₀ of the light emitted from the light emission unit 6, satisfies the following equation 8.

### [Equation 8]

V/V₀=2π/(π−2)(θ₁ sin θ₁+cos θ₁−1) (Equation 8)

In the present modified example, the energy V of the light is set to be 35 mW or less, or the energy V of the light of 35 mW or more and the illuminance per 1 mm² is set to 0.73 μW to 5 mW at. In the case of the present modified example, since the energy of the light in a direction of the irradiation angle θ=0° is highest, when the illuminance per 1 mm² is 5 mW or less at the irradiation angle θ=0°, the illuminance per 1 mm² is always 5 mW or less within a range of 0°≦θ≦θ₁.

Accordingly, the endoscope apparatus 1B of the variant satisfies the explosion-proof standard defined in IEC60079-28.

### Modified Example 2

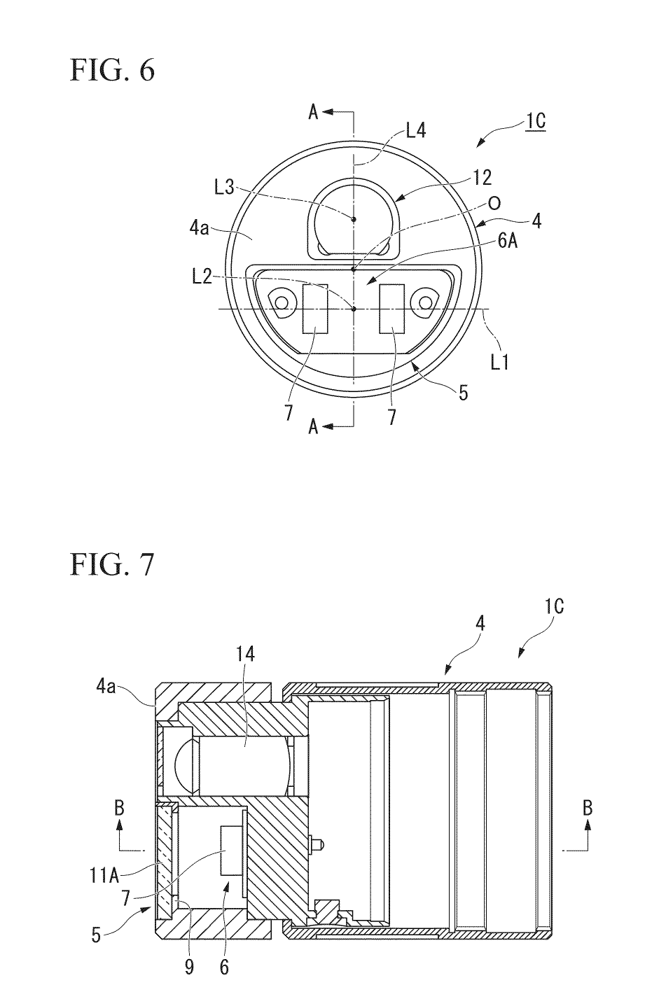

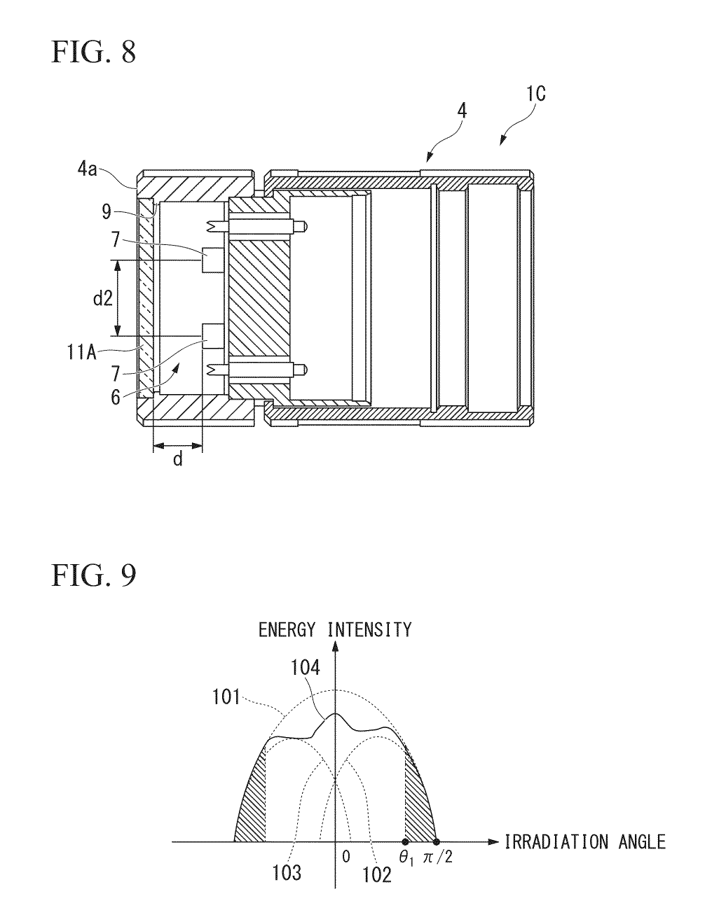

Next, another modified example of the endoscope apparatuses 1 and 1A of the above-mentioned first and second embodiments will be described with reference to FIGS. 6 to 11. FIG. 6 is a front view of the optical adaptor 4 of the endoscope apparatus of the present modified example. FIG. 7 is a cross-sectional view taken along line A-A of FIG. 6. FIG. 8 is a cross-sectional view taken along line B-B of FIG. 6.

An endoscope apparatus 1C of the present modified example is distinguished from the above-mentioned endoscope apparatuses 1, 1A and 1B in that a light emission unit 6A in which a plurality of light sources 7 are installed is provided.

In the present modified example, an optical axis of the light emission unit 6A is different from the optical axis each of the light sources 7. That is, the respective light sources 7 installed at the light emission unit 6A are spaced apart from each other around the optical axis of the light emission unit 6A at predetermined angular intervals, and disposed to be equidistant from the optical axis of the light emission unit 6A. In addition, in the present modified example, the optical axis of each of the light sources 7 is parallel to the optical axis of the light emission unit 6A.

As shown in FIGS. 6 to 8, in the present modified example, two light sources 7 are installed at the light emission unit 6A. The respective light sources 7 are spaced by 180 degrees from each other around the optical axis of the light emission unit 6A and disposed to be spaced by the distance d2 from the optical axis of the light emission unit 6A. The two light sources 7 are disposed in the inside region of the opening of the mask when seen from a front view of FIG. 6.

In the present modified example, in the front view of FIG. 6, a straight line (referred to as reference numeral L1 in FIG. 6) passing through the two light sources 7 installed at the light emission unit 6A is perpendicular to a straight line (referred to as reference numeral L4 in FIG. 6) passing through an optical axis (referred to as reference numeral L2 in FIG. 6) of the light emission unit 6A and an optical axis (referred to as reference numeral L3 in FIG. 6) of the image acquisition unit 12. Further, the straight line (referred to as reference numeral L1 in FIG. 6) passing through the two light sources 7 installed at the light emission unit 6A and a central axis (referred to as reference numeral O in FIG. 6) of the optical adaptor 4 are positions of distortion.

FIG. 9 is a graph showing angular distribution of the light emitted from the illumination unit 5 of the present modified example. In FIG. 9, lines designated by reference numeral 102 and reference numeral 103 are lines showing energy intensity of the light emitted from the respective light sources 7. In addition, in FIG. 9, a line designated by reference numeral 104 is a line showing the energy intensity of the entire light emitted from the light emission unit 6A.

As shown in FIG. 9, the angular distribution of the light emitted from the light emission unit 6A becomes angular distribution combined with the angular distribution of the light emitted from the respective light sources 7.

In the light emission unit 6 described in the variant 1, angular distribution in which energy of the light in a direction (the irradiation angle θ=0°) along the optical axis of the light emission unit 6 is highest is provided (shown by reference numeral 101 in FIG. 9). On the other hand, in the case of the present modified example, the angular distribution of the light emitted from the light emission unit 6A becomes angular distribution combined with the angular distribution of the light sources 7 spaced apart from each other. For this reason, the light emission unit 6A of the present modified example has a flatter angular distribution than that of the modified example 1 near the irradiation angle θ=0°. Accordingly, according to the light emission unit 6A of the variant, illumination irregularity due to a difference in irradiation angle can be reduced in comparison with the light emission unit 6 described in the modified example 1.

In addition, since the illuminance per 1 mm² is defined to be 5 mW or less in IEC60079-28, when the illuminance is 5 mW/mm² or more even when only some of the light is radiated from the illumination unit 5, the illuminance exceeds the range defined in IEC60079-28. For this reason, when the energy of the light at a specific irradiation angle becomes the maximum value, the illuminance at the maximum value should be 5 mW/mm² or less. As a result, when the energy of the light at the specific irradiation angle becomes the maximum value, the quantity of light of the illumination light may be insufficient except at the specific irradiation angle having the maximum value.

On the other hand, in the case of the present modified example, since the angular distribution near the irradiation angle θ=0° is flat, the explosion-proof standard defined in IEC60079-28 can be satisfied without reduction in the total quantity of the radiated light. Accordingly, the endoscope apparatus 1 that can acquire a bright image within a range satisfying the explosion-proof standard can be provided.

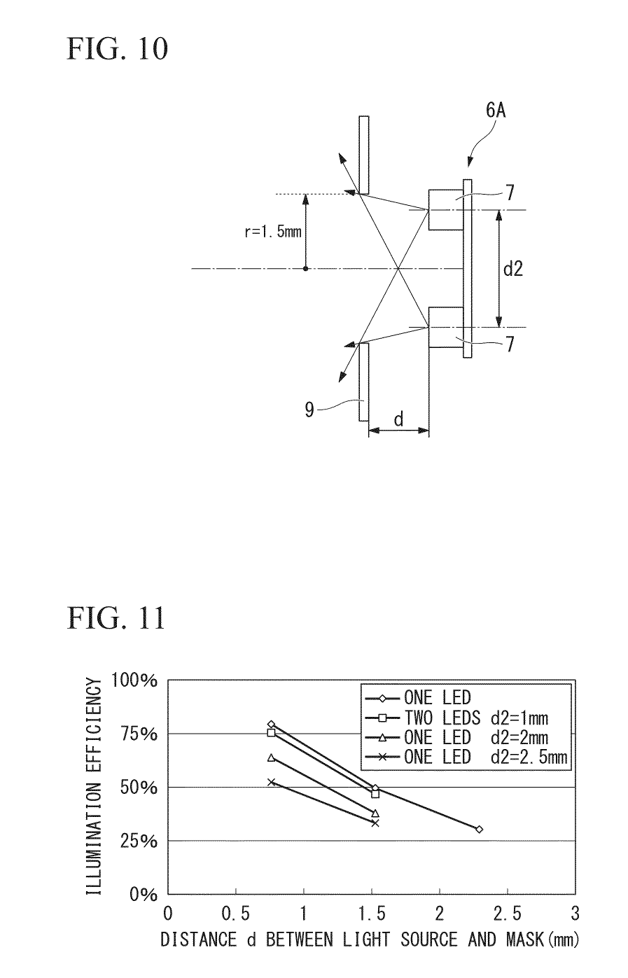

FIG. 10 is a schematic view showing an illumination state by the light emission unit when the mask is opened in a circular shape in which the opening size is a radius of 1.5 mm. FIG. 11 is a graph showing a relationship between the distance from the light source to the mask and illumination efficiency thereof.

As shown in FIG. 10, in the light emission unit 6A of the present modified example in which the two light sources 7 are installed, in comparison with the case in which one light source 7 is installed (for example, see FIG. 4), the irradiation range of the light radiated from the light emission unit 6A through the mask 9 is wide.

In addition, as shown in FIG. 11, when the two light sources 7 are provided, the illumination efficiency can be set to be varied by varying the distance d2 between the two light sources 7. Here, in comparison with the case in which the one light source 7 is provided, the distance d between the mask 9 and the light source 7 can be reduced even at the same illumination efficiency.

In addition, in the modified example 2, while the case in which the two light sources 7 are installed has been exemplarily described, three light sources 7 may be installed to be spaced apart from each other around the optical axis of the light emission unit 6A at angular intervals of 120°. In addition, more than three of the light sources 7 may be installed at the light emission unit 6A.

### Modified Example 3

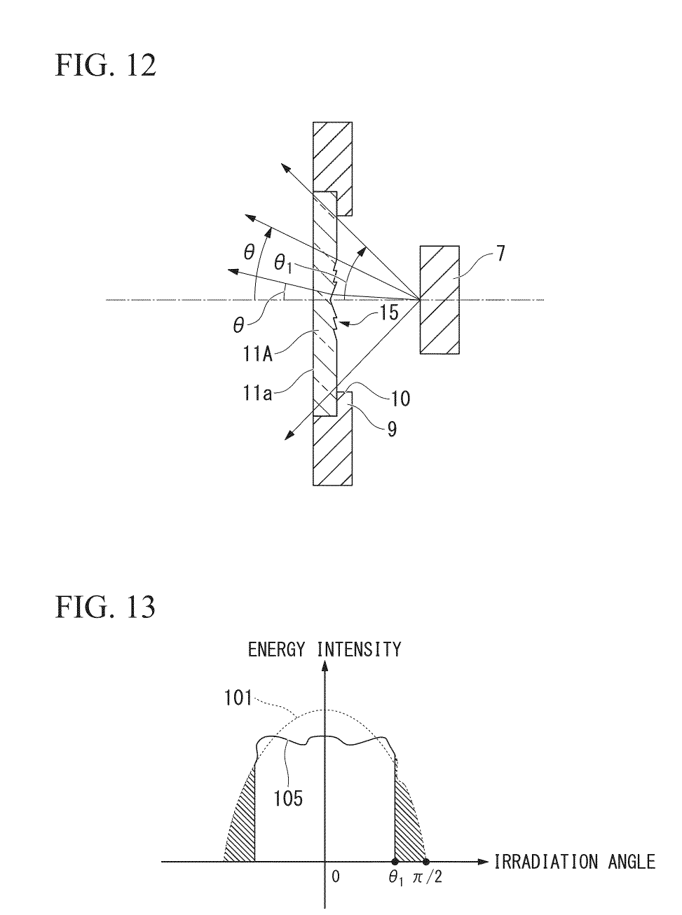

Next, still another modified example of the endoscope apparatuses 1 and 1A of the above-mentioned first and second embodiments will be described. FIG. 12 is a schematic view showing a light distribution property of an illumination unit of the endoscope apparatus of still another modified example of the present invention.

As shown in FIG. 12, the endoscope apparatus 1D of the present modified example is distinguished from the first and second embodiments in that a cover glass 11A has a different shape from the cover glass 11.

The cover glass 11A is a plate-shaped member having the same optical transparency as the cover glass 11 described in the first embodiment. Further, a light distribution control unit 15 configured to control light distribution of the light emitted from the light emission unit 6 such that illuminance of the light output from the cover glass 11A is set to 0.73 μW/mm² to 5 mW/mm² is installed at the cover glass 11A.

Specifically, a surface of the cover glass 11A directed toward the light emission unit 6 is grating-processed as the light distribution control unit 15 within a range in which the illuminance of the light arriving from the light emission unit 6 is set to 0.73 μW/mm² to 5 mW/mm².

In the present modified example, since the Lambert light source described in the modified example 1 is employed as the light source 7 in the light emission unit 6, the energy of the light radiated in a direction along the optical axis is highest. The cover glass 11A formed through the grating processing functions as a diffraction lens configured to diffuse the light radiated from the light emission unit 6 in a direction spaced apart from the optical axis of the light emission unit 6.

FIG. 13 is a graph showing angular distribution of the light emitted from the illumination unit 5 of the present modified example. In FIG. 13, a line designated by reference numeral 105 is a line showing energy intensity of the light emitted from the light emission unit 6, and represents a light distribution property controlled by the light distribution control unit 15.

As shown in FIG. 13, as the light in the optical axial direction having the highest light energy is diffused in the optical axial direction, the cover glass 11A controls light distribution such that the angular distribution of the light energy from the vicinity of the optical axis to the peripheral portion. Accordingly, in the present modified example, illumination irregularity of the illumination light radiated to the observation object is reduced.

In addition, instead of the cover glass 11A, the cover glass 11B concavo-convex processed as a light distribution control unit within a range in which illuminance of the light arrives from the light emission unit 6 is 0.73 μW/mm² to 5 mW/mm² can be employed. A processing method such as sandblasting, etching, or thermoforming may be employed as the concavo-convex processing. As the light in a portion in which the concavo-convex processing is performed is diffused, the cover glass 11B controls the light distribution such that the angular distribution near the optical axis becomes flat.

### Modified Example 4

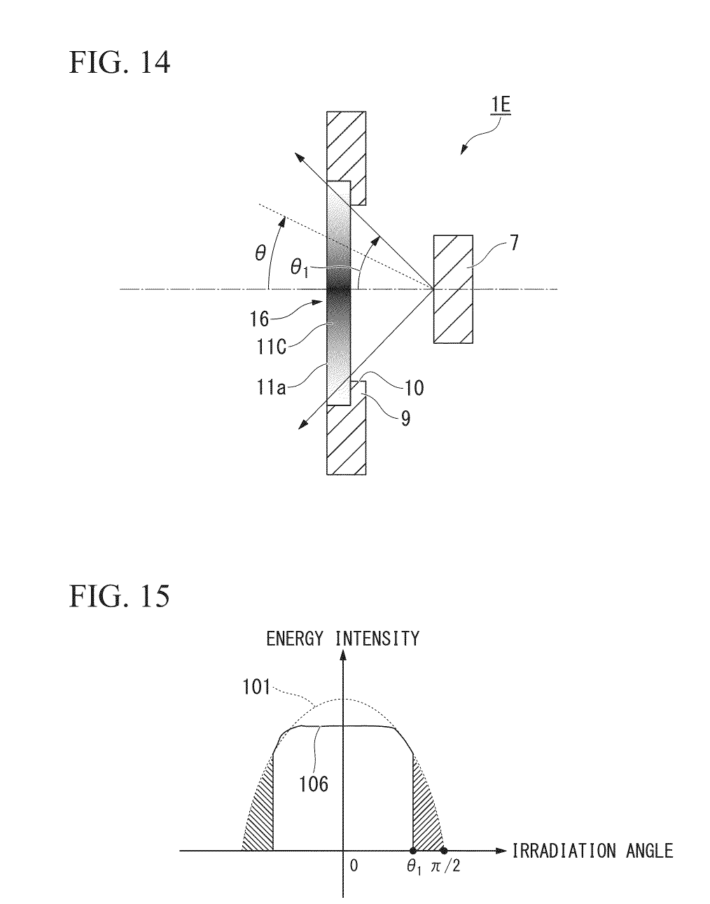

Next, still another modified example of the endoscope apparatuses 1 and 1A of the above-mentioned first and second embodiments will be described. FIG. 14 is a schematic view showing a light distribution property of an illumination unit of an endoscope apparatus of still another modified example of the present invention.

As shown in FIG. 14, an endoscope apparatus 1E of the present modified example is distinguished in that a cover glass 11C is provided instead of the cover glass 11. In addition, the present modified example will be described using an example in which the Lambert light source is employed as the same light source 7 as of the above-mentioned modified example 1.

The cover glass 11C is a plate-shaped member having the same optical transparency as the cover glass 11 described in the first embodiment. Coloration processing (designated by reference numeral 16 in FIG. 14) is performed on the cover glass 11C within a range in which illuminance of the light arriving at the surface of the cover glass 11C from the light emission unit 6 is 5 mW/mm² or more. The coloration processing performed on the cover glass 11C may be employed by appropriately selecting a process of colorizing a color of visible light that can be perceived such as black, gray, or the like. In addition, as the coloration processing, the cover glass 11C may be colored milky-white or may be colored with another color. The coloration processing formed on the cover glass 11C is a light distribution control unit in the present modified example.

A concentration in the case in which the coloration processing is performed with respect to the cover glass 11C is set to a concentration at which illuminance of the light output from the distal end surface 11a of the cover glass 11C is 0.73 μW/mm² to 5 mW/mm². In addition, the coloration processing with respect to the cover glass 11C forms gradation in which the concentration is thickest on the optical axis of the light emission unit 6 and is gradually thinned toward an edge of the cover glass 11C.

FIG. 15 is a graph showing angular distribution of the light emitted from the illumination unit 5 of the present modified example. In FIG. 15, a line designated by reference numeral 106 is a line showing energy intensity of the light penetrating through the cover glass 11C.

As shown in FIG. 15, as the coloration processing is performed on the cover glass 11C, the light emitted from the light emission unit 6 is absorbed at the colored portion of the cover glass 11C. Accordingly, the light output from the distal end surface 4a of the cover glass 11C has the illuminance of 0.73 μW/mm² to 5 mW/mm².

In addition, since the coloration processing with respect to the cover glass 11C forms the gradation in which the concentration is gradually thinned from above the optical axis of the light emission unit 6 to the edge, even when the Lambert light source having the highest energy of the light in the optical axial direction is employed, the energy of the light measured on the distal end surface 11a of the cover glass 11C is substantially constant regardless of the irradiation angle.

Even in the endoscope apparatus 1E of the present modified example, the same effect as described in the above-mentioned first and second embodiments is exhibited.

In addition, since the illuminance is controlled by absorbing some of the light emitted from the light emission unit 6 through the cover glass 11C, the energy of the light can be easily flattened by adjusting the colorized area and concentration.

In addition, in the present modified example, while the case in which the entire cover glass 11C in a thickness direction is colored has been described, at least one of the surfaces in the thickness direction of the cover glass 11C may be colored with, for example, a paint, or the like.

### Example

In the present example, the illumination efficiency (V/V₀) of the illumination unit 5 with respect to the illumination unit 5 in which the Lambert light source is employed as described in the above-mentioned modified example 1 is shown.

In the present example, the illumination efficiency (V/V₀) upon gradual variation of the maximum angle θ₁ was measured by setting the radius of the opening 10 of the mask 9 to 1.5 mm and varying the distance d between the opening 10 and the light emission unit 6.

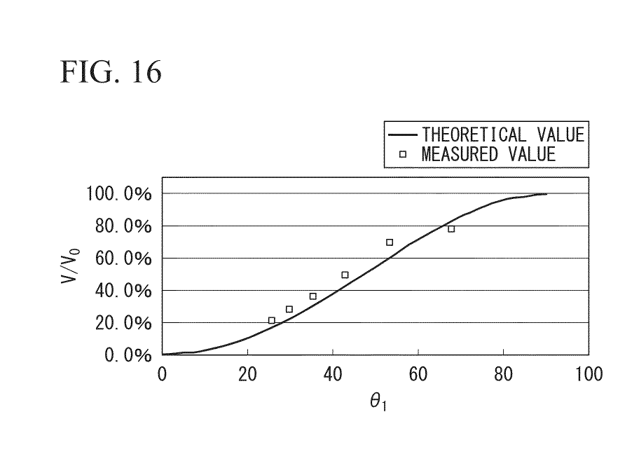

FIG. 16 is a graph showing a relationship between the maximum angle θ₁ and the illumination efficiency of the illumination light radiated from the illumination unit 5. In FIG. 16, the horizontal axis represents the maximum angle θ₁, and the vertical axis represents the illumination efficiency.

As shown in FIG. 16, it will be appreciated that measured values of the maximum angle θ₁ and the illumination efficiency are substantially equal to theoretical values defined by Equation 8.

Hereinabove, while the embodiments, modified examples, and example of the present invention have been described with reference to the accompanying drawings, a specific configuration is not limited to the above embodiments and may include design changes without departing from the spirit of the present invention.

In addition, in the above-mentioned embodiments, while the example satisfying a standard defined in IEC60079-28 has been described, the present invention can be applied to standards other than this.

Further, the components shown in the above-mentioned embodiments and modifications can be appropriately assembled.

### INDUSTRIAL APPLICABILITY

The endoscope apparatus of the present invention can be used as an endoscope apparatus capable of very appropriately acquiring an image of the observation object under the condition in which the energy of the light is limited by the standard or environments in use.

### DESCRIPTION OF REFERENCE NUMERALS

1, 1A, 1B, 1C, 1D, 1E endoscope apparatus
2 insertion section
2a distal end
2b proximal end
3 main body
4 optical adaptor
4a distal end surface
5 illumination unit
6, 6A light emission unit
7 light source
8 terminal
9 mask
10 opening
11, 11A, 11B, 11C cover glass

1. An endoscope apparatus comprising:
an illumination unit configured to radiate an illumination light to an observation object; and
an image acquisition unit configured to acquire an image of the observation object to which the illumination light is radiated,
wherein the illumination unit has:
a light emission unit at which a light source configured to emit the illumination light is installed; and
a mask configured to shield some of the illumination light from the light emission unit, and wherein
when an irradiation angle of the illumination light is set to θ while in a condition where an optical axis of the light emission unit is set to 0°, a function of the irradiation angle θ representing an angular distribution of the illumination light emitted from the light emission unit is set to f(θ), and a maximum angle defined to be vignetted by the mask is set to θ₁ when the optical axis of the light emission unit is set to 0°, an energy V of the light penetrating through the mask represented by the following equation 1 is from 37 μW to 35 mW.
[Equation 1]
V=2π∫θƒ(θ)dθ where (0≦θ≦θ₁) (Equation 1)

2. The endoscope apparatus according to claim 1, wherein the energy V of the illumination light is 8.2 mW or more.

3. An endoscope apparatus comprising:
an illumination unit configured to radiate an illumination light to an observation object; and
an image acquisition unit configured to acquire an image of the observation object irradiated with the illumination light,
wherein the illumination unit has:
a light emission unit at which a light source configured to emit the illumination light is installed; and
a mask configured to shield some of the illumination light emitted from the light emission unit, and wherein
when an irradiation angle of the illumination light is set to θ while in a condition where an optical axis of the light emission unit is set to 0°, a function of the irradiation angle θ representing an angular distribution of the illumination light emitted from the light emission unit is set to f(θ), and a maximum angle defined to be vignetted by the mask is set to θ₁ when the optical axis of the light emission unit is set to 0°, an energy V of the light penetrating through the mask represented by the following equation 2 is 35 mW or more, and illuminance per 1 mm² of the light penetrating through the mask is from 0.73 μW to 5 mW.
[Equation 2]
V=2π∫θƒ(θ)dθ where (0≦θ≦θ₁) (Equation 2)

4. The endoscope apparatus according to claim 2, wherein illuminance per 1 mm² of the light is 0.16 mW or more.

5. The endoscope apparatus according to claim 3, wherein the light emission unit is a Lambert light source, and
the energy V of the illumination light satisfies the following equation 3 when energy of the illumination light emitted from the light emission unit in the direction of the irradiation angle θ of 0° is set to l₀.
[Equation 3]
V=2 πl₀(θ₁ sin θ₁+cos θ₁) (Equation 3)

6. The endoscope apparatus according to any one of claim 1, wherein the maximum angle θ₁ is 20° or more.

7. The endoscope apparatus according to any one of claim 1, wherein the mask has an opening having an opening area of 50 mm² or less.

8. The endoscope apparatus according to any one of claim 1, wherein the maximum angle θ₁ is 20° or more,
the mask has an opening having an opening area of 50 mm² or less, and
a distance in the optical axial direction between the opening of the mask and the light emission unit is 0 mm to 11 mm.

9. The endoscope apparatus according to any one of claim 1, wherein the light emission unit, which is the light source, has at least two light sources spaced apart from each other about the optical axis in a state in which angles measured from around the optical axis are equal to each other, and disposed to be equidistant from the optical axis.

10. The endoscope apparatus according to claim 9, wherein the light source is disposed in an inner region of the opening of the mask when seen in a central axial direction of the mask.

11. The endoscope apparatus according to any one of claim 1, wherein a cover glass having optical transparency is installed on the mask, and the illumination light emitted from the light emission unit passes through the cover glass to be radiated to the observation object.

12. The endoscope apparatus according to any one of claim 11, wherein a light distribution control unit configured to control light distribution of the illumination light emitted from the light emission unit such that illuminance of the illumination light output from the cover glass is 0.73 μW/mm² to 5 mW/mm² is installed on the cover glass.

13. The endoscope apparatus according to claim 12, wherein grating processing or concavo-convex processing is performed on a surface of the cover glass directed toward the light emission unit within a range in which illuminance of the illumination light arriving at the surface from the light emission unit is 0.73 μW/mm² to 5 mW/mm², functioning as the light distribution control unit.

14. The endoscope apparatus according to claim 10, wherein coloration processing is performed on the cover glass within a range in which illuminance of the illumination light arriving at the surface of the cover glass from the light emission unit is 0.73 μW/mm² to 5 mW/mm², functioning as the light distribution control unit.
